(19) United States
(12) Patent Application Publication
(10) Pub. No.: US 2026/0223841 A1
(43) Pub. Date: Aug. 6, 2026

(54) 1-MONOGLYCERIDE OF C12 FATTY ACID FOR THE TREATMENT OR PREVENTION OF INFECTIOUS PLANT DISEASES

(71) Applicant: MBP 4 LIFE, S.L., Zaragoza (ES)

(72) Inventor: Maria Blasco Bigata, Zaragoza (ES)

(21) Appl. No.: 19/152,646

(22) PCT Filed: Feb. 6, 2024
(86) PCT No.: PCT/EP2024/052905

§ 371 Date: Jul. 31, 2025

(30) Foreign Application Priority Data
Feb. 7, 2023 (ES) 23382109.9

(51) Int. Cl. A01N 37/12; A01P 1/00

(52) U.S. Cl. CPC A01N 37/12; A01P 1/00

(57) ABSTRACT

The invention refers to the use of 2,3-dihydroxypropyl dodecanoate for the treatment and/or prevention of a plant infectious disease or condition caused by a gram-negative bacteria selected from the group consisting of Xylella fastidiosa and Candidatus Liberibacter.

This application claims the benefit of the European Patent Application EP23382109.9 filed on Feb. 7, 2023.

### TECHNICAL FIELD

The invention relates to the field of phytosanitary diseases. Particularly, it relates to the use of 1-monoglyceride of C₁₂ fatty acid or a composition containing it for the treatment and/or prevention of diseases or conditions caused by phytopathogenic bacteria.

### BACKGROUND ART

Plants are subjects to attack by pathogens. Many methods for the protection of plants and their production have been widely used for years. The use of biocides for protecting plants and plant productions from pathogen bacterial and/or fungal infections has been widely used. Traditionally, fungicidal, and bactericidal compounds have been used for long to increase yields and extend agricultural production capabilities into new areas. They have also been extremely important tools for ameliorating season-to-season differences in yield and quality caused by weather-driven variations in disease pressure.

However, the extensive use of fungicides and bactericides in agriculture is causing increasing concern due to several undesirable factors, such as the development of resistance, the growing food safety concerns, and also the accumulation of toxic compounds in the environment. As a result, more stringent regulatory restrictions has been implemented on the use of agrochemicals; and the elimination of their residues has caused the disuse and/or the banner of some biocide in agriculture. Therefore, new more effective and safety fungicides and bactericides against plant infections complying with the regulatory affairs rules have been investigate.

However, even though the development of these new generation of biocides, there is still some diseases without effective treatment that cause a huge economic impact for agriculture worldwide. In particular, Xylella fastidiosa and Candidatus Liberibacter are the cause of some of the most destructive disease in plants.

On one hand, Xylella fastidiosa has re-emerged as a global threat for agricultural crops, after its recent introduction in Asia and Europe. Xylella fastidiosa is a plant pathogen which is transmitted by xylem feeding pests such as Philaenus spummarius (commonly known as the spittlebug). Once the insect starts feeding off the xylem fluid (plant sap), the plant gets infected from the bacterium transmitted by the insect and from there everything starts spiralling downwards. Subsequently, the plant starts to die from inside out, as if it was drying itself or starving itself from within. This is what initially causes the plants to wilt and lose their vigor once the plant is infected. After some time, the plant starts to showcase severe symptoms which eventually lead to plant death. This is exactly what makes this pathogen so dangerous since it keeps spreading and there is no cure. Nowadays, there is no solution available on the market to battle the devastation caused by Xylella. Therefore, once the plant is infected, the plant can be considered died; and infected plants must be uprooted or destroyed by means of burning them. There are almost 600 species of plants which are at risk of being infected with Xylella fastidiosa or being potential hosts. These types of plants include a variety of olive trees, lavender, oleander, ash, and many more. That's what makes Xylella so dangerous as it affects a variety of plants. Hence, finding a cure for Xylella fastidiosa has never been more important. It is so important, that it has been added to the list of EU's top 20 priority pests.

On the other hand, Candidatus Liberibacter asiaticus (CLas) is a fastidious, phloem-limited bacterium and the main causative agent of Huanglongbing (HLB, also known as citrus greening disease). Since its emergence in China nearly 100 years ago, a multitude of management strategies have been implemented in an attempt to mitigate the extensive economic damage caused by this pathogen. In areas such as California, where the disease is not yet widespread, management strategies are focused on increased testing for HLB and removal/uprooted (or by burning) of infected trees. However, again, the disease remains prevalent in the majority of citrus producing regions throughout the world. Recent treatment strategies have included a combination of insecticides, antimicrobials, and thermotherapy, but an effective long-term treatment, which is specific for CLas, remains elusive. In December 2018, the U.S. Environmental Protection Agency approved the use of oxytetracycline on citrus; however, CDC and FDA officials have expressed concerns regarding the use of medically important broad-spectrum antibiotics in agriculture. While the use of broad spectrum antibiotics has been shown to be successful in some groves infected with HLB, phytotoxicity is also well documented in the literature, when oxytetracycline is applied at the concentrations needed for efficacy against CLas.

Therefore, despite all the research efforts invested in the development of an effective treatment/control of infectious diseases caused by Xylella fastidiosa and Candidatus Liberibacter, they are far from being satisfactory. Therefore, there is still the long-felt need of finding an effective and safety treatment or prophylaxis for those devasting disease for worldwide agriculture.

### SUMMARY OF INVENTION

The inventors have surprisingly found that the 1-monoglyceride of C12 fatty acid of formula (I) is useful for the treatment and prevention of a plant infectious disease or condition caused by the gram-negative bacteria Xylella fastidiosa or Candidatus Liberibacter.

As it is demonstrated in the experimental section, only the 1-monoglyceride having a fatty acid of 12 carbon atoms (of formula (I)) is unexpectedly effective against the gram-negative bacteria Xylella fastidiosa and Candidatus Liberibacter. In fact, as shown in the comparative examples below, the 1-monoglycerides of formula (I) has not shown an effective antibacterial activity against other classic gram-negative than Xylella and Liberibacter bacteria such as strains of Erwinia, Xanthomonas, and Pseudomonas.

Monoglycerides are primarily used as surfactants, usually in the form of emulsifiers. Together with diglycerides, monoglycerides are commonly added to commercial food products in small quantities as food additive (i.e. E471) which helps to prevent mixtures of oils and water from separating. They are also often found in bakery products, beverages, ice cream, chewing gum, shortening, whipped toppings, margarine, spreads and peanut butter, and confections. In bakery products, monoglycerides are useful in improving loaf volume and texture, and as antistaling agents. Monoglycerides are also used to enhance the physical stability towards creaming in milk beverages.

It is also known that Gram-negative bacteria are more likely to be resistant (in comparison to Gram positive bacteria) to the effects of fatty acids and monoglycerides, presumably due to the presence of an outer membrane (see Churchward C P et al. “Alternative antimicrobials: the properties of fatty acids and monoglycerides” Crit. Rev. Microbiol. 2018, vol 44(5), pp. 561-570; Buňková L. et col. “Comparison of antibacterial effect of seven 1-monoglycerides on food-borne pathogens or spoilage bacteria” Acta Veterinaria Brno, 2011, vol. 80, no. 1; and Wang W. et col. (2020). “In Vitro Antibacterial Activities and Mechanisms of Action of Fatty Acid Monoglycerides against Four Foodborne Bacteria”. Journal of food protection, 2020, 331-337).

Further, monoglycerides are components of plants such as of the root waxes and they can be used as starting material for the preparation of triacylglycerides which can be integrated in the plant membranes as structural components. Therefore, monoglycerides are considered safety compounds for agriculture even when used at high concentrations.

Nevertheless, contrary to what should be expected from the common general knowledge of the skilled in the art, the 1-monoglyceride of the C12 fatty acid is effective against two Gram-negative bacteria, more particularly against two of the most dangerous Gram-negative bacteria, Xylella fastidiosa and Candidatus Liberibacter.

In fact, the inventors have demonstrated that 1-monoglycerides having a fatty acid of 8, 9, 10 and 14 carbon atoms are not appropriate for being use as active ingredient for the treatment or prevention of plant infection, either due to its plant toxicity (i.e. C9 and C10) and/or its low/null effectiveness (i.e. C8 and C14). The 1-monoglycerides having a fatty acid of C8, which is of great interest as antibacterial agent for animal feed (feed field) is not effective for Gram-negative and Gram-positive bacteria of plants. Meanwhile, 1-monoglycerides having a fatty acid of C9 or C10 are derivates of fatty acids used as non-selective herbicides instead of as antibacterial agents in plants.

Finally, the use of non-toxic but an effective dose of 1-monoglyceride of formula (I) according to the present invention supposes a break of the general scientific understanding, as well as the overcome of a long-felt need. These findings are highly advantageous since reveal that the use of the 1-monoglyceride of formula (I) allows treating and/or preventing diseases caused by Xylella fastidiosa and Candidatus Liberibacter, being an important therapy with unmet phytosanitary needs.

Thus, the aspect of the invention relates to the use of a phytosanitary effective amount of a compound of formula (I)

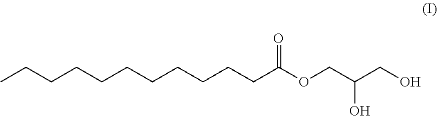 [SMILES: CCCCCCCCCCCC(=O)OCC(O)CO]

for the treatment and/or prevention of a plant infectious disease or condition caused by a gram-negative bacteria selected from the group consisting of Xylella fastidiosa and Candidatus Liberibacter.

### DETAILED DESCRIPTION OF THE INVENTION

All terms as used herein in this application, unless otherwise stated, shall be understood in their ordinary meaning as known in the art. Other more specific definitions terms as used in the present application are as set forth below and are intended to apply uniformly throughout the specification and claims unless an otherwise expressly set out definition provides a broader definition.

For the purposes of the present invention, any ranges given include both the lower and the upper endpoints of the range. Ranges given, such as temperatures, times, weights, and the like, should be considered approximate, unless specifically stated.

As used herein, the term “plant” refers to both monocotyledonous plants and dicotyledonous plants, and includes familiar organisms such as but not limited to trees, herbs, shrubs, and grasses.

The terms “percentage (%) by weight”, “weight/weight %” and “w/w %” have the same meaning and are used interchangeably. They refer to the percentage of one ingredient in relation to the total weight of a composition or mixture. The terms “percentage (%) by weight/volume”, “weight/volume %” and “w/v %” have the same meaning and are used interchangeably. They refer to the percentage of one ingredient in relation to the total volume expressed in mL.

As used herein, the terms “one or more” and “at least one” are synonymous and are used herein indistinctly.

As it is mentioned above, the first aspect of the invention relates to the use of a phytosanitary effective amount of the compound of formula (I) for the treatment and/or prevention of a plant infectious disease or condition caused by a gram-negative bacteria selected from the group consisting of Xylella fastidiosa and Candidatus Liberibacter. In an embodiment, the use of the compound of formula (I) is for the treatment of a plant infectious disease or condition caused by a gram-negative bacteria selected from the group consisting of Xylella fastidiosa and Candidatus Liberibacter. In an embodiment, the use of the compound of formula (I) is for the prevention of a plant infectious disease or condition caused by a gram-negative bacteria selected from the group consisting of Xylella fastidiosa and Candidatus Liberibacter.

For the purpose of the invention, the compound of formula (I) is also known with the non-proprietary names monolaurin, glycerol monolaurate, glyceryl laurate, 1-lauroyl-glycerol which are considered interchangeable. The compound of formula (I) is the mono-ester formed from glycerol and lauric acid that has the IUPAC name 2,3-dihydroxypropyl dodecanoate with the CAS number 142-18-7 and NSC 698570.

As it is mentioned above, the compound of formula (I) is useful for the treatment and/or prevention of a plant infectious disease or condition caused by the phytopathogenic strains of Xylella fastidiosa and Candidatus Liberibacter. For the purpose of the invention the term “Xylella fastidiosa” encompasses those pathogenic subspecies of Xylella fastidiosa such as for example fastidiosa, multiplex, pauca, sandyi, and tashke. The term “Candidatus Liberibacter” encompasses those pathogenic subspecies of Candidatus Liberibacter such as for example asiaticus, africanus, americanus, europaeus, brunswickensis, and solanacearum. Both Xylella fastidiosa and Candidatus Liberibacter are Gram-negative bacteria, which means that are bacteria that do not retain the crystal violet stain used in the Gram staining method of bacterial differentiation known in the state of the art. They are characterized by their cell envelopes, which are composed of a thin peptidoglycan cell wall sandwiched between an inner cytoplasmic cell membrane and a bacterial outer membrane.

In an embodiment, the compound of formula (I) is useful for the treatment and/or prevention of a plant infectious disease or condition caused by the phytopathogenic subspecies of Xylella fastidiosa, wherein the subspecies of Xylella fastidiosa is selected from the group consisting of fastidiosa, multiplex, pauca, sandyi, and tashke. In an embodiment, the compound of formula (I) is useful for the treatment and/or prevention of a plant infectious disease or condition caused by the phytopathogenic subspecies of Candidatus Liberibacter, wherein the subspecies of Candidatus Liberibacter is selected from the group consisting of asiaticus, africanus, americanus, europaeus, brunswickensis, and solanacearum.

In another embodiment, the infectious disease or condition is caused by the phytopathogenic subspecies of Xylella fastidiosa and is selected from the group consisting of Pierce's disease, phony peach rickettsia, olive quick decline syndrome, Citrus variegated chlorosis, alfalfa dwarf disease, plum leaf scald, oleander leaf scorch disease, coffee leaf scorch disease, almond leaf scorch disease, cherry tree leaf scorch disease, sycomoro leaf scorch disease, elm leaf scorch disease, oak leaf scorch disease, mulberry leaf scorch disease, maple leaf scorch disease.

In another embodiment, the infectious disease or condition is caused by the phytopathogenic subspecies of Candidatus Liberibacter and is selected from the group consisting of Huanglongbing (HLB, also known as citrus greening disease), zebra chip disease, chili chlorotic buds, permanent tomato disease.

The term “effective amount” refers to the amount enough to achieve the alleged technical effect, which means that amount of the compound of formula (I) that allows the treatment and/or prevention of a plant infectious disease or condition caused by a gram-negative bacteria selected from the group consisting of Xylella fastidiosa and Candidatus Liberibacter. Further, the term “phytosanitary effective amount” as used herein, refers to the amount of compound of formula (I) as active ingredient that is suitable for being administered or applied in plants by any way (including foliar or intravascular) that allows the treatment and/or prevention of the plant infectious disease or condition mentioned herein above and below.

In an embodiment of the invention, the phytosanitary effective amount is from 0.1 mg to 5000 mg per plant, depending on the size of the plant. In an embodiment of the invention, the phytosanitary effective amount for the treatment and/or prevention of a plant infectious disease or condition caused by Xylella fastidiosa is from 1 mg to 2000 mg per plant. In an embodiment of the invention, the phytosanitary effective amount for the treatment and/or prevention of a plant infectious disease or condition caused by Xylella fastidiosa is from 2 to 200 mg per plant. In an embodiment of the invention, the phytosanitary effective amount for the treatment and/or prevention of a plant infectious disease or condition caused by Candidatus Liberibacter is from 1 mg to 2000 mg per plant. In an embodiment of the invention, the phytosanitary effective amount for the treatment and/or prevention of a plant infectious disease or condition caused by Candidatus Liberibacter is from 2 to 200 mg per plant.

In an embodiment in the invention, the compound of formula (I) forms part of a “phytosanitary composition” comprising the phytosanitary effective amount of the compound of formula (I), and one or more “phytosanitary acceptable excipients and/or carriers”. For the purpose of the present invention, the term “phytosanitary composition” refers to that composition suitable for use in agriculture. Further, the term “phytosanitary acceptable excipients and/or carriers” refers to that excipient or carrier suitable for use in the agriculture technology for preparing compositions with phytosanitary use. It means that either the composition or the excipients or carriers are suitable for use in contact with plants without undue toxicity, incompatibility, instability, undesirable response, among others. The appropriate excipients and/or carriers, and their amounts, can readily be determined by those skilled in the art according to the type of formulation being prepared. Examples of appropriate excipients of carriers include, without being limited to, solvents, cosolvents, diluents, surfactants, emulsifying agents, wetting agents, moisturizing agents, thickeners, stabilizers, rheologic modifiers, adhesive agents, pigments, and dyes, among others. In an embodiment, the compound of formula (I) forms part of a “phytosanitary composition” as defined herein above and below comprising from 0.01 to 99% by weight of the compound of formula (I). In another embodiment, the compound of formula (I) forms part of a “phytosanitary composition” as defined herein above and below comprising from 15-75% by weight of the compound of formula (I). In another embodiment, the compound of formula (I) forms part of a “phytosanitary composition” as defined herein above and below comprising from 20-50% by weight of the compound of formula (I). In another embodiment, the compound of formula (I) forms part of a “phytosanitary composition” as defined herein above and below comprising from 35-45% by weight of the compound of formula (I).

In an embodiment of the invention, the compound of formula (I) forms part of a “phytosanitary composition” as defined herein above and below which is in form of a liquid composition, solid composition, semisolid composition such as gels and creams. In an embodiment of the invention, the treatment and/or prevention comprises a foliar application, a trunk application, a root application, a soil application, or a combination thereof. In a particular embodiment, the treatment and/or prevention comprises a trunk application by injection.

The appropriate form of the phytosanitary composition, its excipients and/or carriers, and their amounts, can readily be determined by those skilled in the art according to the type of application. In an embodiment of the invention, the compound of formula (I) forms part of a “phytosanitary composition” which is a foliar topical composition in form of a liquid, solid or a gel. In an embodiment of the invention, the compound of formula (I) forms part of a “phytosanitary composition” which is a liquid trunk or root injectable composition. The term “liquid” composition encompasses solutions, suspensions, emulsions, liposomes, micelles, colloids, and particles (micro- and nano-particles). The term “solid” composition encompasses powder (soluble of dispersible powder), granules (including dispersible or soluble granules), and capsules.

In an embodiment of the invention, the compound of formula (I) forms part of a “phytosanitary composition” selected from ready-to-use composition or concentrated composition. The ready-to-use composition encompasses compositions that are in such a form that are appropriate for its direct use in agriculture. Meanwhile, the concentrated compositions require a subsequent step for diluting it until having the phytosanitary effective amount of the compound of formula (I).

In an embodiment, the compound of formula (I) forms part of a “phytosanitary composition” absorbed or adsorbed in a solid support. In an embodiment, the compound of formula (I) forms part of a “phytosanitary composition” absorbed or adsorbed in a solid support which is selected from the group consisting of a mineral based support, a polymeric based support and/or organic based support. In an embodiment, the compound of formula (I) forms part of a “phytosanitary composition” absorbed or adsorbed in a solid support, wherein the solid support is a mineral based support selected from the group consisting of silica, bentonite, sepiolite, active carbon, diatomaceous earth, and a combination thereof. In an embodiment, the compound of formula (I) forms part of a “phytosanitary composition” absorbed or adsorbed in a solid support, wherein the solid support is a polymeric based support selected from the group consisting of starch polymers, cellulose polymers, lignin polymers, chitosan and nanochitosan polymers, polyacrylamide, polyvinyl alcohols, polycaprolactone, polylactic acid, polyacrylate, polyhydroxyalkanoate, polyvinylacetate. In an embodiment, the compound of formula (I) forms part of a “phytosanitary composition” absorbed or adsorbed in a solid support, wherein the solid support is an organic based support selected from the group consisting of compost, manure, lignin, cellulose, chitosan, humic acids, fulvic acids, treatment plants sludge, sawdust, straw and organic slurries and wastes from biomass industries.

In an embodiment of the invention, the compound of formula (I) forms part of a “phytosanitary composition” as defined herein above as unique active ingredient for the treatment or prevention of a plant infectious disease or condition caused by Xylella fastidiosa or Candidatus Liberibacter.

In an embodiment of the invention, the compound of formula (I) forms part of a “phytosanitary composition” as defined herein above and below further comprising at least one additional active ingredient. In an embodiment of the invention, the compound of formula (I) forms part of a “phytosanitary composition” as defined herein above and below further comprising at least one additional active ingredient selected from the group consisting of pesticides, antifungal agents, antibacterial agents, essential oils, amino acid based compounds and mixture thereof. Examples of additional antifungal agents include, but is not limited to tebuconazole, difenoconazole, fluquinconazole, azoxystrobin, propiconazole, carbendazim, flutriafol, fluopyram, mancozeb, prochloraz, kresoxim-methyl, epoxiconazole, imazalil, metconazole, prothioconazole-desthio, mefentrifluconazole, bixafen, boscalid, fluxapyroxad, folpet, fenhexamid, thiophanate-methyl, Amphotericin B, Nystatin, Natamycin or mixtures thereof. Examples of additional antibacterial agents include, but is not limited to, copper compounds, dithiocarbamates, amides, sulfonamides, aminoglycosides, cephalosporins, macrolides, quinolone, tetracycline, penicillins, dimetridazole. Examples of additional essential oils include, but is not limited to, essential oils of Origanum, cinnamon, eucalyptus, lemon grass, peppermint, orange, lemon, palmarosa, laurel, citronella, geranium, rosewood, patchouli, thyme, salvia, clove, mint, pepper, lavender, and mixtures thereof. Examples of additional pesticides include, but is not limited to organochlorines, organophosphates, carbamates, and mixture thereof.

Examples of additional amino acid based compounds include, but is not limited to oligopeptide, polypeptide, proteins, enzymes, hemolysins, antibodies and mixture thereof.

In an embodiment, the use of the compound of formula (I) is for the treatment of a plant infectious disease or condition caused by a gram-negative bacteria selected from the group consisting of Xylella fastidiosa and Candidatus Liberibacter, wherein the treatment comprises applying the phytosanitary effective amount as defined above of the compound of formula (I) or a composition comprising it to a plant infected by the gram-negative bacteria. In an embodiment, the use of the compound of formula (I) is for the prevention of a plant infectious disease or condition caused by a gram-negative bacteria selected from the group consisting of Xylella fastidiosa and Candidatus Liberibacter, wherein the prevention comprises applying the phytosanitary effective amount as defined above of the compound of formula (I) or a composition comprising it to a plant susceptible of being infected by the gram-negative bacteria.

In an embodiment, the use of the compound of formula (I) is for the treatment or prevention of a plant infectious disease or condition caused by a gram-negative bacteria selected from the group consisting of Xylella fastidiosa and Candidatus Liberibacter, and the treatment or prevention comprises applying at least one application. In an embodiment, the use of the compound of formula (I) is for the treatment or prevention of a plant infectious disease or condition caused by a gram-negative bacteria selected from the group consisting of Xylella fastidiosa and Candidatus Liberibacter, and the treatment or prevention comprises applying a first application and at least one additional application at daily, weekly, monthly, or annual frequency after the first application.

The compositions comprising a phytosanitary effective amount of the compound of formula (I) use in the present invention can be prepared according to methods well known in the state of the art. The appropriate method and conditions can readily be determined by those skilled in the art according to the type of formulation and way of application.

Throughout the description and claims the word “comprise” and variations of the word, are not intended to exclude other technical features, additives, components, or steps. Furthermore, the word “comprise” encompasses the case of “consisting of”. Additional objects, advantages and features of the invention will become apparent to those skilled in the art upon examination of the description or may be learned by practice of the invention. The following examples are provided by way of illustration, and they are not intended to be limiting of the present invention. Furthermore, the present invention covers all possible combinations of particular and preferred embodiments described herein.

### EXAMPLES

### 1. Antibacterial Effectivity Test

### 1.1. In-Vitro Test

### General Considerations

The antibacterial effectivity of the compound of formula (I) of the present invention was tested with the target Gram-negative pathogenic Xylella fastidiosa and with the cultured surrogate Liberibacter crescens for the functional Genomics of uncultured pathogenic “Candidatus Liberibacter spp”.

As it is mentioned above, Candidatus Liberibacter spp. are uncultured insect endosymbionts and phloem-limited bacterial plant pathogen associated with the disease Huanglongbing (or citrus “greening”). Research on this pathogen has been stymied by the inability to culture it and to re-inoculate into any host. Only a single isolate of a single species of Liberibacter, Liberibacter crescens, has been axenically cultured. L. crescens strain BT-1 is genetically tractable to standard molecular manipulation techniques and has been developed as a surrogate model for functional studies of genes, regulatory elements, promoters, and secreted effectors derived from the uncultured pathogenic Candidatus Liberibacter (see M. Jain et al. “Liberibacter crescens is a cultured surrogate for functional genomics uncultured pathogenic “Candidatus Liberibacter” spp. And is naturally competent for transformation”. Phytopathology, 2019, vol. 109, pp. 1811-1819; and Blacutt et al. “An in vitro pipeline for screening and selection of citrus-associated microbiota with potential anti-“Candidatus Liberibacter asiaticus” Properties, Applied and Environmental Microbiology, 2020, vol. 86(8) pp e02883-19).

### 1.1.1. Bacteria

The antibacterial in-vitro effectivity of the compound of formula (I) of the present invention was tested with the following Gram-negative bacteria strains:
Xylella fastidiosa subsp. fastidiosa IVIA5387.2
Xylella fastidiosa subsp. multiplex IVIA5901
Xylella fastidiosa subsp. pauca DeDonno
Liberibacter crescens strain BT-1
Xanthomonas campestris pv. vesicatoria strain 206 (USA)
Pseudomonas syringae pv. syringae strain EPS 94 (Girona, Spain)
Erwinia amylovora EPS101 (Lleida, Spain)

As an example, the above tested strains came from pathogens collection of Vegetal Health Innovation and Development Center-University of Girona. Nevertheless, any other available bacterial strains mentioned above obtained according to the state of the art can also be used (for instance, by taking a sample from a plant with a disease or condition caused by such a bacteria and cultivating it). These strains were used as examples of bacteria strains for performing the microbiological test of the composition of formula (I) in the present application. As previously indicated, the invention does not involve the use of or concerns the said biological material.

### 1.1.2. Samples

The compound of formula (I) was tested at different concentrations and the results were compared with the commercially available antibacterial agent copper oxychloride suspension as a positive control (ZZ Cuprocol; Sygenta, 70% w/v copper oxychloride suspension) at the recommended manufacturers' dose.

Moreover, several negative control samples (which do not promote any bactericide effect) were also included. Comparative samples are disclosed herein below:
Comparative control 1 wherein the compound of formula (I) was replaced for distillate water,
Comparative control-OH 2 wherein the compound of formula (I) was replaced for ethanol,
Comparative sample 3 wherein the compound of formula (I) was replaced by the 1-monoglyceride having a fatty acid of 8 carbon atoms, and
Comparative sample 4 wherein the compound of formula (I) was replaced by the 1-monoglyceride having a fatty acid of 14 carbon atoms.

### Sample Preparation.

The commercially available capsule of 1 g of Glycerol 1-monolaurate of formula (I) (monolaurin) was dissolved in ethanol following the instructions of the supplied, for having the following sample concentrations 12.5, 25, 50, 75, 100, 250, 500 and 1000 μg/ml.

ZZ Cuprocol was provided as a suspension (Sygenta) comprising copper oxychloride at 70% w/v and was tested at a concentration of 0.75 ml/L or 1.5 ml/L.

### 1.1.3. Method

The determination of the bactericidal activity was performed by means of the called “killing assay” with the suspension of the bacteria in liquid medium. The method comprised mixing 100 μl of the appropriate concentration of the sample to be tested with 100 μl of the bacterial suspension at a stock concentration of 2×10⁸ CFU/ml, obtaining a final volume of 200 μl in each well of the microplate (bacterial suspension at a final concentration approximately 10⁸ CFU/ml). The multi-well plates were incubated at 28° C. under constant agitation (150 rpm). After 30 and 120 minutes (min) of exposure of the bacterial strain to the different concentrations, samples were taken, and their survival (CFU/ml) were analyzed by counting viable cells in agar.

For Pseudomonas syringae pv. Syringae Strain EPS 94

In this particular embodiment, 250 μg/ml of compound of formula (I), 250 μg/ml of comparative 1-acylglyceride having a fatty acid of 8 carbon atoms, and 1.5 ml/L of Cuprocol were tested.

The Colony-forming unit were counted at 24 hours of incubation for Pseudomonas and the survival (CFU/ml) were compared with control samples. Three samples for each concentration and time were carried out.

For Xanthomonas campestris pv. vesicatoria

In this particular embodiment, 250 μg/ml of compound of formula (I) and a 1.5 ml/L of Cuprocol were tested. The Colony-forming unit were counted at 24 hours of incubation for Xanthomonas, and the survival (CFU/ml) were compared with control samples. Three samples for each concentration and time were carried out.

For Xylella fastidiosa

The inoculum was obtained from pure culture of active growing strain of Xylella fastidiosa after incubation in agar (BCYE for subsp. fastidiosa IVIA5387.2 and PD2 for subsp. multiplex IVIA5901 and subsp. pauca DeDonno) for at 28° C. for 7-10 days, bacterial suspension was adjusted to final concentration of 1×10⁸ CFU/ml.

In this particular embodiment, four concentrations of the compound of formula (I) (250, 100, 75 and 50 μg/ml), 250 μg/ml of comparative 1-monoglyceride having a fatty acid of 8 carbon atoms, 250 μg/ml of comparative 1-monoglyceride having a fatty acid of 14 carbon atoms and a concentration of 0.75 ml/L of Cuprocol were tested for Xylella fastidiosa subsp. fastidiosa IVIA5387.2 bacterium, and one concentration of the compound of formula (I) (250 g/ml) was tested for Xylella fastidiosa subsp. multiplex IVIA5901 and Xylella fastidiosa subsp. pauca DeDonno bacterium.

The Colony-forming unit were counted at 10 days after the incubation and the survival (CFU/ml) were compared with control samples. Three samples for each concentration and time were carried out.

For Liberibacter crescens (being the Cultured Surrogate Model for Functional Genomics of Uncultured Pathogenic ‘Candidatus Liberibacter’ Spp.)

The inoculum was obtained from pure culture of active growing strain of Liberibacter crescens after incubation in agar BM7 at 28° C. for 4-7 hours, bacterial suspension was adjusted to final concentration of 5×10⁷ UFC/ml. In this particular embodiment, two concentrations of the compound of formula (I) (100 and 250 μg/ml), 250 μg/ml of comparative 1-monoglyceride having a fatty acid of 8 carbon atoms, 250 μg/ml of comparative 1-monoglyceride having a fatty acid of 14 carbon atoms and a concentration of 0.75 ml/L of Cuprocol were tested for each bacterium.

The Colony-forming unit were counted at 10 days after of incubation and the survival (CFU/ml) were compared with control samples. Three samples for each concentration and time were carried out.

For Erwinia amylovora

The inoculum was obtained from pure culture of active growing strain Erwinia amylovora after incubation in agar LB at 28° C. for 7-10 days, bacterial suspension was adjusted to final concentration of 1×10⁸ CFU/ml.

In this particular embodiment, six concentrations of monolaurin (50, 100, 250 500 and 1000 μg/ml) and a concentration of 0.75 ml/L of Cuprocol were tested for each bacterium.

The Colony-forming unit were counted at 24 hours after of incubation and the survival (CFU/ml) were compared with control samples. Three samples for each concentration and time were carried out.

### 1.1.4. Results

The results are shown in Table 1, which includes the bacterial survival (CFU/ml) in the different tested conditions, including the compound of formula (I) according to the present invention; control samples (i.e., comparative control distilled water and comparative control-ethanol); and the comparative positive sample antibacterial agent (Cuprocol).

TABLE 1

| Samples | | Survival (CFU/ml) | |
|---|---|---|---|
| Tested samples | Amount | At 30 min | At 120 min |

Liberibacter Test (Liberibacter crescens strain BT-1 as cultured Surrogate model for Candidatus
Liberibacter spp.)

| Comparative negative control 1 | — | | 6.41 | 7.87 |
|---|---|---|---|---|
| Comparative negative Control-OH 2 | — | | 7.27 | 8.21 |
| Comparative sample 3 (1-monoglyceride C8) | 250 | μg/ml | 7.41 | 6.96 |
| Comparative sample 4 (1-monoglyceride C14) | 250 | μg/ml | 4.41 | 2.94 |
| Comparative Cuprocol (Positive control) | 0.75 | ml/L | 0 | 0 |
| Compound of formula (I) of the invention | 250 | μg/ml | 0 | 0 |
| | 100 | μg/ml | 0 | 0 |

Xylella Test (Xylella fastidiosa subsp. Fastidiosa)

| Comparative negative control 1 | — | | 8.18 | 8.19 |
|---|---|---|---|---|
| Comparative negative Control-OH 2 | — | | 8.08 | 8 |
| Comparative sample 3 (1-monoglyceride C8) | 250 | μg/ml | 7.08 | 4.53 |
| Comparative sample 4 (1-monoglyceride C14) | 250 | μg/ml | 5.67 | 4.48 |
| Comparative Cuprocol (Positive control) | 0.75 | ml/L | 0 | 0 |
| Compound of formula (I) of the invention | 250 | μg/ml | 0 | 0 |
| | 100 | μg/ml | 0 | 0 |
| | 75 | μg/ml | 0 | 0 |
| | 50 | μg/ml | 2.26 | 1.87 |

Xylella Test (Xylella fastidiosa subsp. Multiplex)

| Comparative negative Control-OH 2 | — | | 8.17 | 8.03 |
|---|---|---|---|---|
| Comparative Cuprocol (Positive control) | 0.75 | ml/L | 0 | 0 |
| Compound of formula (I) of the invention | 250 | μg/ml | 0 | 0 |

Xylella Test (Xylella fastidiosa subsp. Pauca DeDonno)

| Comparative negative Control-OH 2 | — | | 6.20 | 6.05 |
|---|---|---|---|---|
| Comparative Cuprocol (Positive control) | 0.75 | ml/L | 0 | 0 |
| Compound of formula (I) of the invention | 250 | μg/ml | 0 | 0 |

Xanthomonas Test (Xanthomonas campestris pv. Vesicatoria)

| Comparative negative control 1 | — | | 8.24 | 8.2 |
|---|---|---|---|---|
| Comparative negative Control-OH 2 | — | | 8.16 | 8.13 |
| Comparative Cuprocol (Positive control) | 1.5 | ml/L | 6.66 | 5.13 |
| Compound of formula (I) of the invention | 250 | μg/ml | 7.87 | 7.75 |

Pseudomonas Test (Pseudomonas syringae pv. Syringae)

| Comparative negative control 1 | — | | 8.06 | 8.11 |
|---|---|---|---|---|
| Comparative negative Control-OH 2 | — | | 8.07 | 8.05 |
| Comparative Cuprocol (Positive control) | 1.5 | ml/L | 4.06 | 0 |
| Comparative sample 3 (1-monoglyceride C8) | 250 | μg/ml | 7.94 | 8.01 |
| Compound of formula (I) of the invention | 250 | μg/ml | 8.03 | 7.79 |

For Erwinia amylovora, bacterial growing was observed (without performing a quantitative test) in all concentrations at 30 and 120 minutes. Therefore, no bactericidal effect of the compound of formula (I) was observed against Erwinia amylovora.

As it is shown in the Table above, the compound of formula (I) is effective ONLY for Gram-negative pathogenic bacteria Xylella fastidiosa and Candidatus Liberibacter. Meanwhile, for all tested bacteria, the survival of the untreated controls (with water and ethanol) was approximately 100%, at both times analyzed (30 min and 2 h); and no growth of the bacteria was observed at 30 min and 2 h of exposure with the reference bactericide Cuprocol at 0.75 or 1.5 ml/L.

In particular, for Xylella fastidiosa, after treatment with the 1-monoglyceride of formula (I) of the present invention at 100 and 75 μg/ml, no growth of Xylella was observed either at 30 or 120 minutes of contact, which means a mortality about 100%. Furthermore, In the treatment with 50 μg/ml, a survival of about 27.6% (log CFU/ml of 2.26) and 23.1% (Log CFU/ml of 1.87) was observed after 30 min and 120 min of contact respectively. Therefore, it is concluded that 1-monoglyceride of C12 fatty acid of formula (I) has a powerful bactericidal action against Xylella fastidiosa subsp. fastidiosa IVIA5387.2, showing a minimum bactericidal concentration (MBC) after 30 minutes of contact closer to 50 μg/ml, and lower than 250 μg/ml against Xylella fastidiosa subsp. multiplex IVIA5901 and Xylella fastidiosa subsp. pauca DeDonno. Thus, it can be concluded that the compound of formula (I) is effective against Xylella fastidiosa.

Furthermore, for Candidatus Liberibacter (being tested with the Cultured Surrogate model Liberibacter crescens strain BT-1). The survival of the untreated controls (with water and ethanol) after treatment with the 1-monoglyceride of formula (I) of the present invention at 100 and 250 μg/ml, no growth of was observed either at 30 or 120 minutes of contact, which means a mortality about 100%. Therefore, it is concluded that 1-monoglyceride of C12 fatty acid of formula (I) has a powerful bactericidal action against Candidatus Liberibacter showing a minimum bactericidal concentration (MBC) after 30 minutes of contact lower than 100 μg/ml, based on the aforementioned models. Therefore, it can be concluded that the compound of formula (I) is effective against Candidatus Liberibacter.

On the other hand, for Erwinia amylovora, Xanthomonas campestris and Pseudomonas syringae, the survival of the bacteria exposed to the 1-monoglyceride of formula (I) was approximately 100%, at both times analyzed (30 min and 2 h). Therefore, it is concluded that 1-monoglyceride of C₁₂ fatty acid of formula (I) does not have ANY antibacterial activity against Erwinia, Xanthomonas or Pseudomonas.

### 1.1.5. Conclusions of In-Vitro Antibacterial Assay

The results of the in-vitro bactericide test demonstrate that a 1-monoglyceride of C12 fatty acid of formula (I) has an appropriate minimum bactericidal concentration (MBC) for being used as effective agent (antibacterial agent). And, therefore, useful as active agent for the treatment and/prevention of a plant infectious disease caused by Xylella fastidiosa or Candidatus Liberibacter.

1.2. In-Vivo Vascular and Systemic Antibacterial Effectivity Test Against Xylella fastidiosa

The in-vivo effectivity of the compound of formula (I) of the present invention was only tested with plants infected with Xylella fastidiosa subsp. fastidiosa IVIA5387.2. However, since the Candidatus Liberibacter bacterium is not cultivable, it is not possible to scale up the laboratory results in controlled conditions, since it is not possible to infect plants in a controlled way and, therefore, establish the performance of potential remedies.

### 1.2.1. Bacteria

The in-vivo effectivity of the compound of formula (I) of the present invention was tested out in one-year-old almond trees with Xylella fastidiosa subsp fastidiosa IVIA5387.2

As an example, the above tested strain came from pathogens collection of Vegetal Health Innovation and Development Center-University of Girona. Nevertheless, any other available bacterial strains mentioned above prepared according to the state of the art can also be used. Further, the almond plants (Prunus dulcis) from the cultivars Avijor, Soleta, and Penta provided by Agromillora S.L.U. (Spain) were used for the experiments. Nevertheless, any other commercially available Prunus dulcis can also be used.

### 1.2.2. Samples

The compound of formula (I) was tested as a solution having a concentration of 33 mg/ml. The results were compared with a negative control sample (which do not promote any bactericide effect) wherein the compound of formula (I) was replaced for distillate water.

### 1.2.3. Method

The one-year-old almond plants were maintained in 0.8-liter pots in an environmentally controlled greenhouse maintained at 25±2° C. (day) and 18±2° C. (night), with a minimum relative humidity of 60%, and with a photoperiod of 16 h light and 8 h dark. Before and during the experiments, plants were watered to saturation every 3 days and fertilized with a 200-ppm solution of nitrogen: phosphorus: potassium (NPK) (20:10:20) once a week. Also, throughout the experiments, standard treatments with insecticide and acaricide were performed to eliminate insect vectors or pests. However, fungicide and bactericide treatments were avoided in order to exclude interferences with the assay.

The inoculum of Xylella fastidiosa subsp. fastidiosa IVIA5387.2. was obtained from pure culture of active growing strain after incubation in agar BCYE at 28° C. for 7-10 days, bacterial suspension was adjusted to final concentration of 1×10⁸ CFU/ml.

Almond plants were inoculated with a high-precision microinjector (NanoJet; Chemyx, Stafford, TX) provided with a Hamilton 250-μl syringe with a thin needle with a beveled tip (Bonaduz, Switzerland). The needle end was introduced through approximately half the plant stem diameter to inoculate the Xylella fastidiosa inside the vascular system.

The plants were treated with a solution of the compound of formula (I) at 33 mg/ml. The trial was performed with preventive/curative combined strategy, that is, first, injection of monolaurin (preventive treatment), then, inoculation with the bacteria, and finally, new injection of monolaurin (therapeutic treatment). The preventive treatment consisted in the inoculation of the compound of formula (I) 24 hours before bacteria inoculation. The curative treatment consisted in inoculation of the compound of formula (I) 72 hours after pathogen inoculation. The trunk microinjection was performed with 3 applications of 10 μl in 3 inoculation points along 8 cm stem section. Three inoculations of the Xylella fastidiosa suspension of 10 μl each (30 μl of total inoculum/plant) were applied at the same side of the stem. The treatment was 2 mg/plant of the compound of formula (I). The results were compared with a control sample, where the monolaurin solution was replaced by sterile water. The experimental design consisted of three repetitions of three plants per dosage.

The Severity scale used to rate almond plants for almond leaf scorch (ALS) disease development was performed using the methodology disclosed in the state of the art (see. Baró et al. “Aggressiveness of Spanish Isolates of Xylella fastidiosa to Almond Plants of Different Cultivars Under Greenhouse Conditions”. Phytopathology. 2021, vol 111:11, pp. 1994-2001). The severity was scored from 0 to being: 0: no symptoms; 1: from 1 to 5 leaves just beginning to show marginal necrosis; 2: from 5 to 10 leaves showing significant marginal necrosis; 3: one half or more of leaves showing marginal necrosis; 4: all leaves showing heavy scorching or falling; and 5: dead plant. The severity levels were quantified within 55, 62, 82, 115 and 140 days after inoculation.

### 1.2.4. Results

The results obtained from the in vivo assay in almond trees are shown in Table 2 expressed as the arithmetic media of all tested assays, which includes the score of the severity scale for both tested dosage of compound of formula (I) at 55, 62, 82, 115 and 140 days after inoculation.

### Treatment Assay:

| | Days after infection | | | | |
|---|---|---|---|---|---|
| Tested samples | 55 | 62 | 82 | 115 | 140 |
| Comparative Control | 0.61 | 0.72 | 1.65 | 2.5 | 3 |
| Compound of formula (I) | 0.11 | 0.44 | 0.42 | 1.17 | 2.33 |
| (33 mg/ml) | | | | | |

As it is shown in the results of Table above, the use of the compound of formula (I) shows a beneficial activity against the undesired effects caused by the infection of Xylella fastidiosa, even wherein the Xylella has been treated directly by the inoculation of the compound of formula (I) in the vascular system of the plant. In fact, after 140 days the beneficial effect is still observed without the need of inoculating a second dose of the compound of formula (I).

Without not being bound to any theory it seems that the compound of formula (I) can have a double effect against the Gram negative Xylella fastidiosa and Candidatus Liberibacter related to a combination of a direct antibacterial effect and an indirect effect by the inhibition of the formation/growing of the bacterial biofilms, being a synergistic effect.

### 1.3. Conclusions

Regarding the in vitro and in vivo assays disclosed in the present application, it is concluded that the compound of formula (I) is useful as active ingredient for the treatment and/or prevention of a plant infectious disease or condition caused by Xylella fastidiosa and Candidatus Liberibacter.

### 2. Compositions

### 2.1. Liquid Compositions

### 2.1.1. Foliar Liquid Compositions Comprising the 1-Monoglyceride C₁₂ Fatty Acid

Reference liquid compositions for the foliar application comprising the 1-monoglyceride C₁₂ fatty acid of formula (I) are disclosed herein below.

Table 1 discloses the ingredients, their function and their amount expressed in weight percent in relation to the total weight of the composition.

TABLE 1

| | | | Amount |
|---|---|---|---|
| Ingredients | Commercial product | Function | (% by weight) |
| C12 fatty acid 1- | monolaurin 90%⁽¹⁾ | Active ingredient | 30 |
| monoglyceride | | | |
| Ethoxylated Octyl Phenol | Citowett ® | Wetting agent | 10 |
| Polyoxyethylene-20- | Tween 80 | surfactant | 15 |
| sorbitan monooleate | | | |
| vegetable oil | Agri-pure ™ AP-406⁽²⁾ | Bio-solvent | 45 |

⁽¹⁾Monolaurin 90% contains 10% of free glycerol, diglyceride, and triglyceride
⁽²⁾Agri-pure ™ AP-406: plant based rapeseed oil methyl ester commercialized by Cargill; any other vegetable oil suitable for agriculture could be used instead.

This formulation was dispersed in water in a ratio of 0.5 liter formulation/hectoliter of water (0.5% v/v) and, after stirring at 1000 rpm, it kept stable for more than 120 minutes. The mixture was carried out at 50° C.

### Concentrated Foliar Liquid Composition

A concentrated dispersion in water comprising the formulation of Table 1 was prepared by firstly, mixing all the ingredients listed in table above; and secondly, dispersing the resulting mixture in water in a ratio of 0.1-5 liter of formulation per hectoliter of water (resulting in a final concentration of 0, 1-5% v/v) and, after strong stirring at 1000 rpm for 5 minutes, it kept stable for more than 120 minutes. The mixture was carried out at 50° C.

### 2.1.2. Foliar Liquid Compositions Comprising 1-Monoglyceride C₁₂ Fatty Acid and Biocide Active Ingredients

Reference liquid compositions for foliar application comprising 1-monoglyceride C₁₂ fatty acid and additional biocide active ingredients are disclosed herein below.

### Liquid Compositions Comprising 1-Monoglyceride C₁₂ Fatty Acid and Herb Essential Oil

A reference liquid composition for foliar application comprising 1-monoglyceride C₁₂ fatty acid of formula (I) and at least one essential oil is disclosed herein below. Any other essential oil can be used instead of Origanum essential oil.

Table 2 discloses the ingredients, their function and their amount expressed in weight percent in relation to the total weight of the composition.

TABLE 2

| | | | Amount |
|---|---|---|---|
| Ingredients | Commercial product | Function | (% by weight) |
| C12 fatty acid 1- | monolaurin 90%⁽¹⁾ | Active ingredient | 30 |
| monoglyceride | | | |
| Ethoxylated Octyl Phenol | Citowett ® | Wetting agent | 10 |
| Polyoxyethylene-20- | Tween 80 | surfactant | 15 |
| sorbitan monooleate | | | |
| vegetable oil | Agri-pure ™ AP-406 | Bio-solvent | 35 |
| Origanum essential oil | | Active ingredient | 10 |

⁽¹⁾Monolaurin 90% contains 10% of free glycerol, diglyceride, and triglyceride
(2) Agri-pure ™ AP-406: plant based rapeseed oil methyl ester commercialized by Cargill; any other vegetable oil suitable for agriculture could be used instead.

A diluted aqueous dispersion comprising the formulation of Table 2 was prepared following the processes disclosed in previous section adding the herb essential oil for preparing the first mixture of ingredients.

### Liquid Compositions Comprising 1-Monoglyceride C₁₂ Fatty Acid of Formula (I) and a Fungicide

A reference liquid composition for foliar application comprising 1-monoglyceride C₁₂ fatty acid of formula (I) and at least one fungicide agent is disclosed herein below. Any other fungicide disclosed in the state of the art can be used.

Table 3 discloses the ingredients, their function and their amount expressed in weight percent in relation to the total weight of the composition.

TABLE 3

| | | | Amount |
|---|---|---|---|
| Ingredients | Commercial product | Function | (% by weight) |
| C12 fatty acid 1- | monolaurin 90%⁽¹⁾ | Active ingredient | 30 |
| monoglyceride | | | |
| Ethoxylated Octyl Phenol | Citowett ® | Wetting agent | 10 |
| Polyoxyethylene-20- | Tween 80 | surfactant | 15 |
| sorbitan monooleate | | | |
| vegetable oil | Agri-pure ™ AP-406⁽²⁾ | Bio-solvent | 38 |
| Copper oxychloride | ZZ Cuprocol | Active ingredient | 7 |
| suspension⁽³⁾ | | | |

⁽¹⁾Monolaurin 90% contains 10% of free glycerol, diglyceride, and triglyceride
⁽²⁾Agri-pure ™ AP-406: plant based rapeseed oil methyl ester commercialized by Cargill; any other vegetable oil suitable for agriculture could be used instead.
⁽³⁾In form of 70% w/v copper oxychloride suspension

A diluted aqueous dispersion comprising the formulation of Table 3 was prepared following the processes disclosed in previous section adding the antifungal agent for preparing the first mixture of ingredients.

### 2.1.3. Nanoemulsion Liquid Foliar Composition

The 1-monoglyceride of formula (I) can be presented in nano-emulsions as well as other kind of nano-formulation.

The nano-formulation is in form of oil-in-water nanoemulsion comprising 1-monoglyceride C₁₂ fatty acid of formula (I). The droplet size was between 200-400 nm measured by nanoparticle tracking analysis (NTA).

Table 4 discloses the ingredients, their function and their amount expressed in grams.

TABLE 4

| | Commercial | | Amount |
|---|---|---|---|
| Ingredients | product | Function | (g) |
| C12 fatty acid 1- | monolaurin | Active ingredient | 35 |
| monoglyceride | 90%⁽¹⁾ | | |
| Soy lecithin | — | Emulsifying agent | 10 |
| Polyoxyethylene sorbitan | Tween 40 | surfactant | 5 |
| monopalmitate | | | |
| water | — | Solvent | 50 |

⁽¹⁾Monolaurin 90% contains 10% of free glycerol, diglyceride, and triglyceride

The monolaurin was mixed with the soy lecithin at 50° C. by use of strong stirring (4000 rpm) for 5 minutes. On the other hand, water was mixed with the surfactant at 50° C. by use of strong stirring (4000 rpm) for 5 minutes. Both solutions were mixed at 50° C. by use of strong stirring (4000 rpm) for 10 minutes. After that, the mixture was sonicated with an ultrasound probe (Hielscher UP200st, 26 kHz) for 12 minutes at 50° C. The temperature was controlled during the ultrasound applied step by a cooling jacket, and the resulting mixture in nano-dispersion form was stable for at least three days.

### 2.2. Solid Compositions

### 2.2.1. Solid Compositions for Soil Sprinkling Application

Exemplary compositions of a mineral solid absorption composition for soil sprinkling application is disclosed herein below. Instead silica, other minerals can be used as bentonite, sepiolite, active carbon, diatomaceous earth and/or combinations thereof, among others.

Table 5 discloses the ingredients, their function and their amount expressed in weight percent in relation to the total weight of the composition.

TABLE 5

| | | | Amount |
|---|---|---|---|
| | | | (% by |
| Ingredients | Commercial product | Function | weight) |
| 1-monoglyceride | monolaurin 90%⁽¹⁾ | Active ingredient | 35 |
| C12 fatty acid | | | |
| Silica | IQE D300 | support | 63 |
| Silica | IQE Ibersil D100 | fluidizing agent | 2 |

⁽¹⁾Monolaurin 90% contains 10% of free glycerol, diglyceride, and triglyceride

The 1-monoglyceride C12 fatty acid was added as spray at 70° C. to a rotary drum where the mixture of silica (IQE D300/IQE Ibersil D100) was already placed. The drum rotated at 30 rpm.

### CITATION LIST

1. Churchward C P et al. “Alternative antimicrobials: the properties of fatty acids and monoglycerides” Crit. Rev. Microbiol. 2018, vol 44 (5).
2. Buňková L. et col. “Comparison of antibacterial effect of seven 1-monoglycerides on food-borne pathogens or spoilage bacteria” Acta Veterinaria Brno, 2011, vol. 80, no. 1.
3. Wang W. et col. (2020). “In Vitro Antibacterial Activities and Mechanisms of Action of Fatty Acid Monoglycerides against Four Foodborne Bacteria”. Journal of food protection, 2020, 331-337
4. M. Jain et al. “Liberibacter crescens is a cultured surrogate for functional genomics uncultured pathogenic “Candidatus Liberibacter” spp. And is naturally competent for transformation”. Phytopathology, 2019, vol. 109, pp. 1811-1819.
5. Blacutt et al. “An in vitro pipeline for screening and selection of citrus-associated microbiota with potential anti-“Candidatus Liberibacter asiaticus” Properties, Applied and Environmental Microbiology, 2020, vol. 86 (8) pp e02883-19).
6. Baró et al. “Aggressiveness of Spanish Isolates of Xylella fastidiosa to Almond Plants of Different Cultivars Under Greenhouse Conditions”. Phytopathology. 2021, vol 111:11, pp. 1994-2001.

1-15. (canceled)

16. A method for treating or preventing a plant disease or condition caused by a gram-negative bacterium selected from the group consisting of Xylella fastidiosa and Candidatus 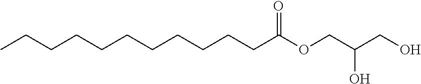 [SMILES: CCCCCCCCCCCC(=O)OCC(O)CO]
Liberibacter, the method comprising applying a phytosanitarily effective amount of a compound of formula (I) to a plant in need thereof.

17. The method according to claim 16, wherein the gram-negative bacterium is a Xylella fastidiosa selected from the group consisting of X. fastidiosa fastidiosa, X. fastidiosa multiplex, X. fastidiosa pauca, X. fastidiosa sandyi, and X. fastidiosa tashke.

18. The method according to claim 16, wherein the gram-negative bacterium is a Candidatus Liberibacter selected from the group consisting of C. L. asiaticus, C. L. africanus, C. L. americanus, C. L. europaeus, C. L. brunswickensis, and C. L. solanacearum.

19. The method according to claim 16, wherein the phytosanitarily effective amount of the compound of formula (I) is from 0.1 mg to 5000 mg.

20. The method according to claim 19, wherein said amount is from 1 mg to 2000 mg per plant, optionally from 2 mg to 200 mg per plant.

21. The method according claim 16, wherein the compound of formula (I) is part of a phytosanitary composition comprising one or more phytosanitarily acceptable excipients or carriers.

22. The method according to claim 21, wherein the composition comprises from 0.01% to 99% by weight of the compound of formula (I).

23. The method according to claim 22, wherein the composition comprises from 15% to 75% by weight of the compound of formula (I).

24. The method according to claim 21, wherein the composition further comprises at least one additional active ingredient.

25. The method according to claim 24, wherein said additional active ingredient is selected from the group consisting of pesticides, antifungal agents, antibacterial agents, essential oils, amino acid-based compounds, and mixtures thereof.

26. The method according to claim 16, wherein the composition or compound of formula (I) is applied in a form selected from the group consisting of liquid, solid, and gel.

27. The method according to claim 16, wherein the application is selected from foliar, trunk, root, soil, or combinations thereof.

28. The method according to claim 27, wherein the trunk application is by injection.

29. The method according to claim 16, wherein the treatment or prevention comprises at least one application of the phytosanitarily effective amount of the compound or composition.

30. The method according to claim 16, wherein the disease is caused by Xylella fastidiosa and is selected from the group consisting of Pierce's disease, phony peach rickettsia, olive quick decline syndrome, citrus variegated chlorosis, alfalfa dwarf disease, plum leaf scald, oleander leaf scorch disease, coffee leaf scorch disease, almond leaf scorch disease, cherry tree leaf scorch disease, sycamore leaf scorch disease, elm leaf scorch disease, oak leaf scorch disease, mulberry leaf scorch disease, and maple leaf scorch disease; or is caused by Candidatus Liberibacter and is selected from Huanglongbing (HLB), zebra chip disease, chili chlorotic buds, and permanent tomato disease.
